(19) United States
(12) Patent Application Publication
(10) Pub. No.: US 2020/0111057 A1
(43) Pub. Date: Apr. 9, 2020

(54) TEMPORARY JOB LOCATOR AND MATCHER APPLICATION SYSTEM

(71) Applicant: Sarah C. Penland, Arlington, TX (US)

(72) Inventor: Sarah C. Penland, Arlington, TX (US)

(21) Appl. No.: 16/179,185

(22) Filed: Nov. 2, 2018

Related U.S. Application Data
(60) Provisional application No. 62/741,798, filed on Oct. 5, 2018.

(51) Int. Cl. G06Q 10/10; G06Q 10/06; G06F 17/30; G06Q 50/22

(52) U.S. Cl. CPC G06Q 10/1053; G06Q 10/063112; G06Q 50/22; G06F 17/30873; G06F 17/30867

(57) ABSTRACT

A temporary job locator and matcher application system enables trained and skilled dental professionals to locate temporary positions made available by employers through a portal. The location or other aspects of the temporary positions are used to match potential employees with these temporary positions. Rapid response and local availability play a major role in preventing disruptions in the dental or other industries.

### BACKGROUND

### 1. Field of the Invention

The present invention relates generally to temporary job placement systems, and more specifically, to an application system for locating temporary jobs and local professionals particularly in the dental industry.

### 2. Description of Related Art

Temporary job placement systems are well known in the art and are effective means to post the need for a worker on a limited basis and connect potential candidates with the offeror. For example, FIG. 1 depicts a conventional temp agency system 101 having am employer 103, a placement agency 105 and employees 107. During use, the employer 103 will send notice of a position 109 to the agency 105 who will then attempt to match an employee 107 to the position 109. If or when a match is found the employee 107 is sent to the employer 103 for the duration of the position 109.

One of the problems commonly associated with system 101 is its limited use. For example, positions that required skilled labor or labor in high demand will remain open as no employee with this skill will likely be looking for short-term employment.

Additionally, in order to fill an unexpected open position, the agency will need to have a qualified candidate who does not have work always on standby.

Accordingly, although great strides have been made in the area of temp agency system, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common temp agency system;

FIG. 2 is a schematic of a temporary job locator and matcher application system in accordance with a preferred embodiment of the present application;

FIG. 3 is a flowchart of the portal of FIG. 2;

FIG. 4 is a diagram of the profile of the potential employee of FIG. 3;

FIG. 5 is a diagram of the temporary position of the employer of FIG. 3;

FIG. 6 is a front view of an embodiment of the portal of FIG. 2;

FIG. 7 is a flowchart of the preferred method of use of the system of FIG. 2; and

FIG. 8 is a flowchart of the preferred use of an alternative embodiment of the system of FIG. 2.

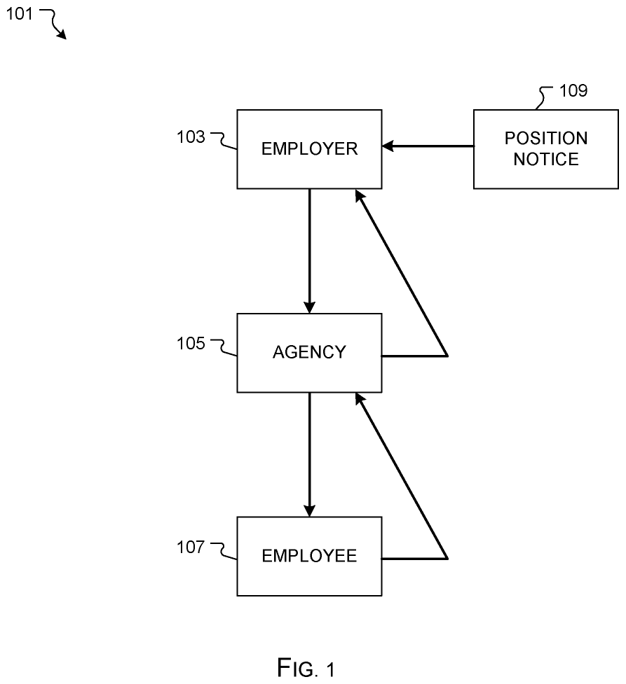

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional temp agency systems. Specifically, the system of the present application enables the placement of skilled individuals on a temporary basis. In addition, skilled labor will be readily available and at their own discretion. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

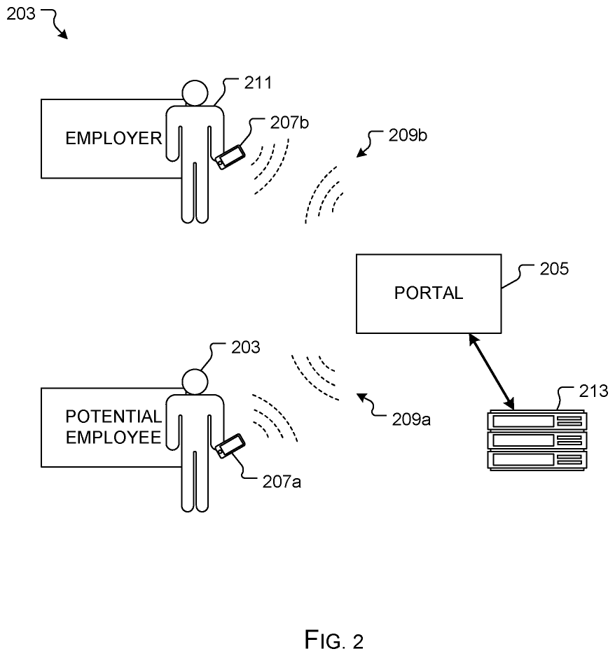

Referring now to the drawings wherein like reference characters identify corresponding or similar elements throughout the several views, FIG. 2 depicts a schematic of a temporary job locator and matcher application system in accordance with a preferred embodiment of the present application. It will be appreciated that system 201 overcomes one or more of the above-listed problems commonly associated with conventional temp agency systems.

In the contemplated embodiment, system 201 includes potential employees 203 and employers 211 in communication with a portal 205 via their respective computing devices 207 and a network 209. The portal 205 has access to a database 213.

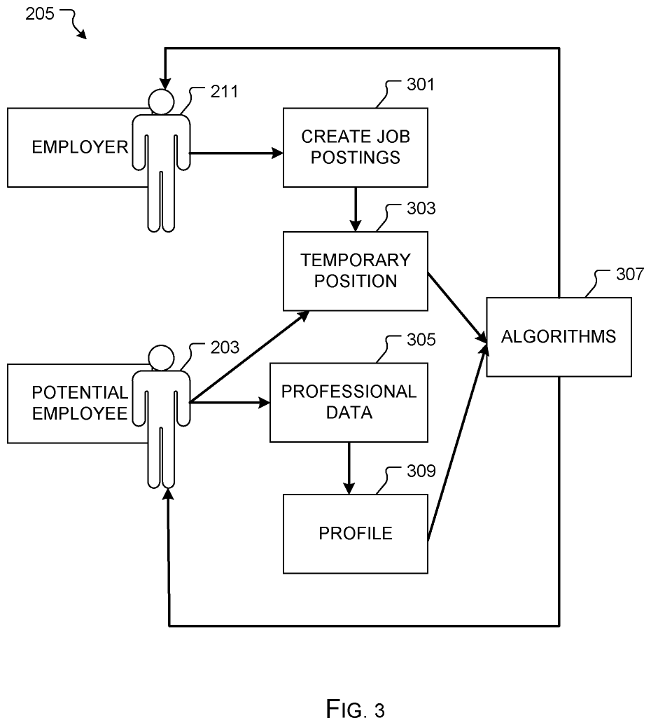

Referring now to FIG. 3 the portal 205 allows an employer 211 to create a job posting 301 for a temporary position 303. The job postings 301 are available to be viewed and applied for by the potential employees 203. The portal 205 accepts professional data 305 from the potential employees 203 to form a profile 309 for the submitting potential employee 203. The portal 205 includes algorithms 307 that narrow the potential employees 203 to those with skills or attributes pertinent to the job posting 303 in question.

In use, the portal 205 matches listed job postings 301 with potential employees 203 by the professional data 305. The matching could be by the employer 211 finding the potential employee 203, the potential employee 203 finding a job posting 301 and the portal selecting a potential employee 203 for a job posting 301.

It should be appreciated that one of the unique features believed characteristic of the present application is that skilled potential employees 203 who look for temporary work are able to see and review available job postings that meet their availability. It will be appreciated that the system 201 provides rapid access to skilled potential employees 203.

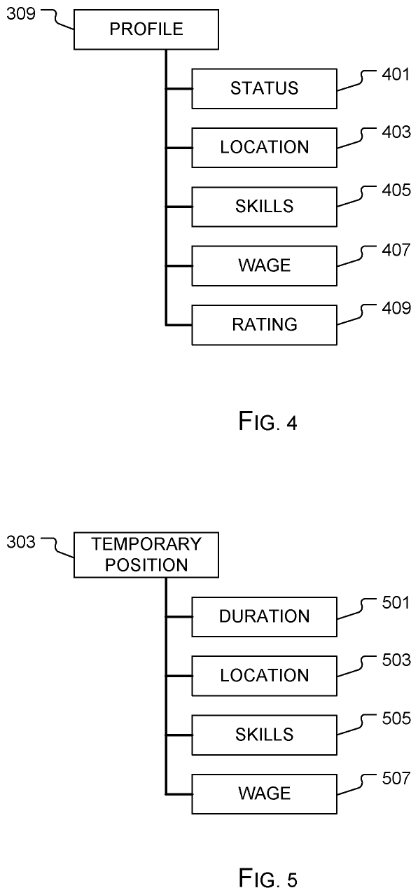

Referring now to FIG. 4 a contemplated embodiment of a profile 309 of a potential employee 203. The profile 309 includes the status 401 of the potential employee 203 their location 403, skills 405, anticipated or past wage 407 and a performance rating 409. These examples of professional data 305 are given not to limit the scope data that could be utilized by the portal 205 but are given as one contemplated set of data.

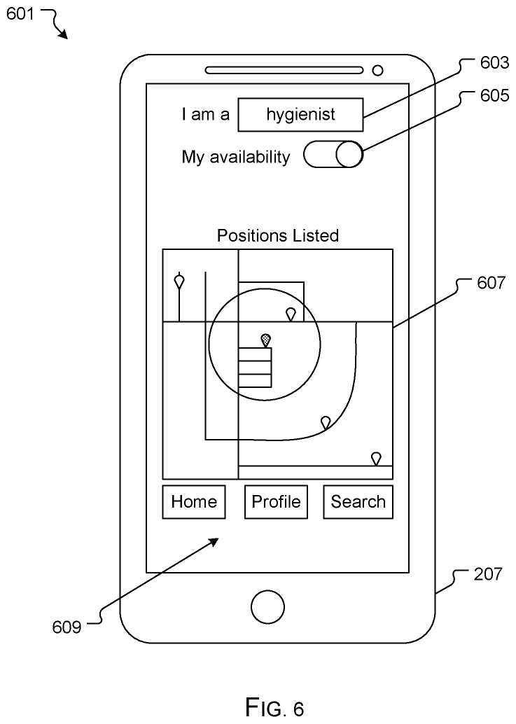

As depicted by FIG. 5 a contemplated embodiment of a temporary position 303 includes the duration 501, location 503, skills required 505 and offered wage 507.

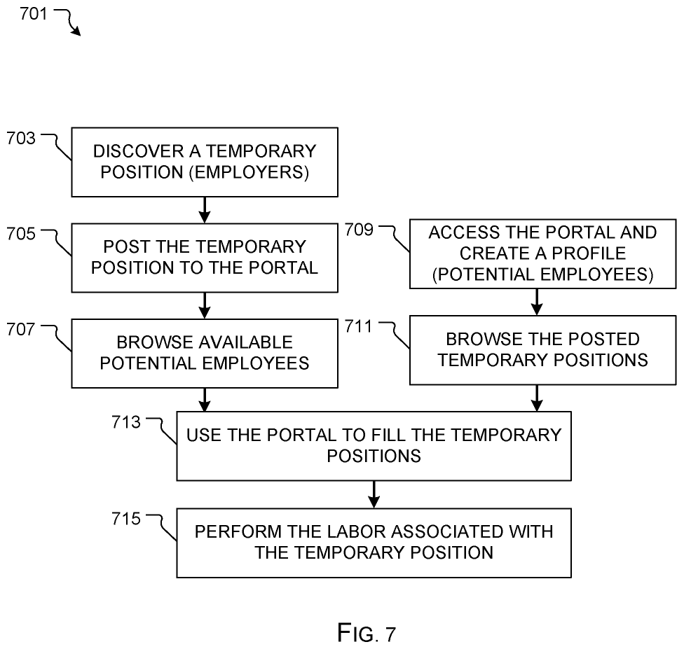

Referring now to FIG. 6 an embodiment of the portal 303 as seen by a potential employee 303 is depicted. Embodiment 601 includes a job classification 603 an availability status 605, a map view of temporary positions 607 and options 609. The portal 601 being accessed by computing device 207. It will be appreciated that the potential employee 203 is able to quickly communicate to the employers 211 if they are available for work. It will be understood that in the case of illness or accident employers 211 will have little to no time to find a replacement and that by listing their current status 605 the position 303 will promptly be filled. It will also be appreciated that the potential employee 203 is able to find the closest position 303 to their present location or other location.

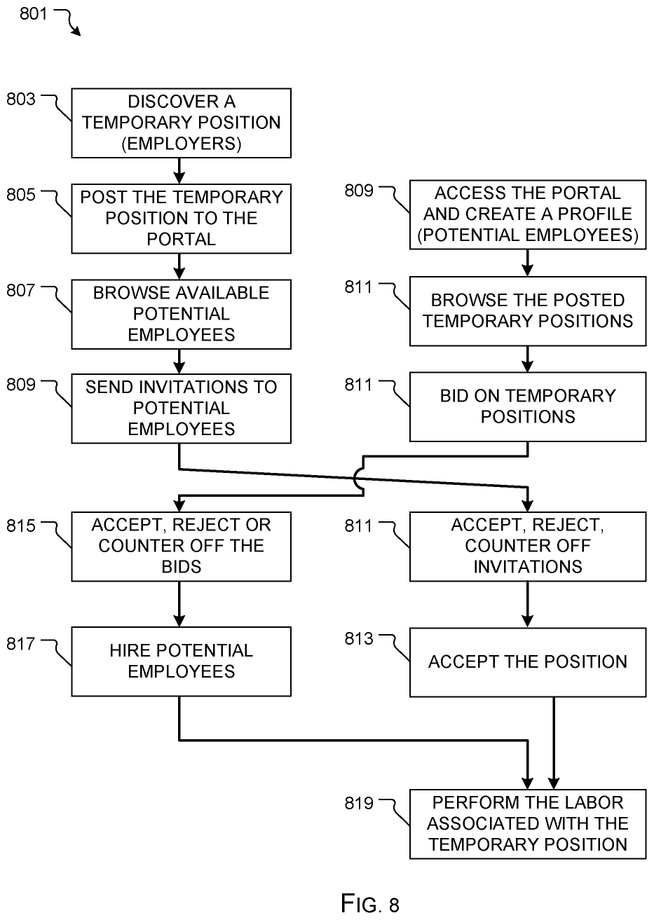

Referring now to FIG. 7 the preferred method of use of the system 201 is depicted. Method 701 includes discovering a temporary need by an employer 703, posting the temporary position to the portal 705, browsing available potential employees 707, accessing the portal and creating a profile by potential employees 709 browsing the posted temporary positions 711 using the portal to fill the temporary positions 713 and performing the labor associated with the temporary position 715.

Referring now to FIG. 8 an alternative embodiment of the system 201 is depicted. Embodiment 801 includes features similar to that of 201 where the algorithms 307 have been replaced or augmented with a bidding tool where both the employer 211 and potential employee 203 are able to signal their intent to hire or fill the position respectively as depicted by steps 809-817.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A temporary job locator and matcher application system comprising:
a portal having a database in communication with at least one employer and at least one potential employee;
wherein the at least one employer posts at least one temporary position that is accessible to the potential employees; and
wherein the at least one temporary position is filled via the portal by the at least one potential employees.

2. The system of claim 1 wherein the at least one potential employees submit professional data to create at least one profile that facilitates matching with a temporary position.

3. The system of claim 1 wherein location data is used to fill the at least one temporary positions.

4. The system of claim 1 wherein the at least one temporary positions are in the dental industry.

5. The system of claim 1 wherein the at least one temporary positions are in the education sector.

6. The system of claim 1 wherein the employer offers a temporary position to a potential employee.

7. The system of claim 1 wherein the potential employee bids on filling a temporary position.

7. The method of filling temporary positions given the system of claim 1, comprising:
discovering a temporary need by an employer;
posting the temporary position to the portal;
browsing available potential employees;
accessing the portal and creating a profile by potential employees;
browsing the posted temporary positions;
using the portal to fill the temporary positions; and
performing the labor associated with the temporary position.
